(19) United States
(12) Patent Application Publication
(10) Pub. No.: US 2006/0110311 A1
(43) Pub. Date: May 25, 2006

(54) Catalyst composite and methods of making and using

(76) Inventor: Felice DiMascio, Rocky Hill, CT (US)

Correspondence Address: CANTOR COLBURN, LLP, 55 GRIFFIN ROAD SOUTH, BLOOMFIELD, CT, 06002, US

(21) Appl. No.: 11/265,032

(22) Filed: Nov. 2, 2005

Related U.S. Application Data
(60) Provisional application No. 60/624,685, filed on Nov. 3, 2004.

(51) Int. Cl. B01J 23/40; B01J 31/00; C01B 11/02

(52) U.S. Cl. 423/477; 502/325; 502/159

(57) ABSTRACT

A catalyst composite includes an agglomerate of a plurality of catalyst composite components and a binder. The catalyst composites may be useful as a catalyst in a variety of chemical processes including hydrogenation, dehydrogenation, hydrogenolysis, oxidation, reduction, alkylation, dealkylation, carbonylation, decarbonylation, coupling, isomerization, amination, deamination, or hydrodehalogenation.

### CROSS REFERENCE TO RELATED APPLICATIONS

This application claims the benefit of U.S. Provisional Patent Application Ser. No. 60/624,685, filed Nov. 3, 2004, which is incorporated herein by reference in its entirety.

### BACKGROUND

This disclosure generally relates to catalyst composites, wherein the composite includes a heterogeneous catalyst.

Catalysts, which may generally take the form of heterogeneous, homogeneous, or biological catalysts, are of significant importance to the chemical industry as evidenced by the fact that the great majority of all chemicals produced have been in contact with a catalyst at some point during their production. Despite the many advances in the areas of homogeneous and biological catalysis, heterogeneous catalysts remain the predominant form used by industry. Heterogeneous catalysts are favored in part because they tolerate a much wider range of reaction temperatures and pressures, they can be more easily and inexpensively separated from a reaction mixture by filtration or centrifugation, they can be regenerated, and they are less toxic than their homogeneous or biological counterparts.

A heterogeneous catalyst is generally a solid material that operates on reactions taking place in the gaseous or liquid state, and generally includes a reactive species and a support for the reactive species, which optionally may be porous. One problem associated with heterogeneous catalysts is desorption of the reactive species from the support. When the number of the catalyst's reactive species decreases, the catalyst is not as effective and the reaction rate and/or product selectivity is reduced. Another disadvantageous feature of heterogeneous catalysts is catalyst attrition through the release of catalyst fines, which are small particles of spent catalyst that can remain in the reaction mixture and/or pass into the products. The generation of catalyst fines can also have a deleterious effect on catalyst performance. Furthermore, removal of catalyst fines can become an expensive and/or time-consuming step during the production process. Yet another disadvantage of heterogeneous catalysts is bypassing or channeling of the catalyst by the reactant mixture. When the reaction mixture bypasses the catalyst, the reaction may not proceed as efficiently, product yield may decrease, and product contamination may occur. Yet still another disadvantage associated with heterogeneous catalysts is pressure drop. If the reactant mixture cannot pass through a catalyst chamber properly a pressure drop may occur and a large amount of power, which may be in the form of additional applied pressure, will be required to push the reactant mixture through the chamber.

Despite their suitability for their intended purposes, there nonetheless remains a need in the art for new and improved devices for use as heterogeneous catalysts. It would be particularly advantageous if such catalyst devices could eliminate or result in decreased desorption of the reactive species from the support. It would further be advantageous if such catalyst devices eliminated or minimized release of catalyst fines, channeling or bypassing, and pressure drop.

### BRIEF SUMMARY

Disclosed herein is a catalyst composite, which comprises an agglomerate of a plurality of catalyst composite components and a binder, wherein the catalyst composite components comprise a reactive species, a support, a promoter, an ion exchange material, or a combination comprising at least one of the foregoing catalyst composite components.

A method for making a catalyst composite comprises mixing a plurality of catalyst composite components with a binder to form a mixture, wherein the catalyst composite components comprise a reactive species, a support, a promoter, an ion exchange material, or a combination comprising at least one of the foregoing catalyst composite components; and processing the mixture to form the catalyst composite, wherein the catalyst composite comprises an agglomerate of a plurality of catalyst composite components held together with the binder.

A method for catalyzing a chemical process comprises contacting a reaction mixture with catalyst composite, wherein the catalyst composite comprises an agglomerate of a plurality of catalyst composite components and a binder, wherein the catalyst composite components comprise a reactive species, a support, a promoter, an ion exchange material, or a combination comprising at least one of the foregoing catalyst composite components; and increasing a reaction rate for the reaction mixture to produce a product.

The above described and other features are exemplified by the following figures and detailed description.

### BRIEF DESCRIPTION OF THE DRAWINGS

Referring now to the Figures, which are exemplary embodiments, and wherein the like elements are numbered alike:

FIG. 1 is a schematic representation of a catalyst composite in accordance with one embodiment;

FIG. 2 is a schematic representation of a catalyst composite in accordance with a second embodiment; and

FIG. 3 is a schematic representation of a catalyst composite in accordance with a third embodiment.

### DETAILED DESCRIPTION

Disclosed herein are catalyst composites and methods for making and using the catalyst composites. The catalyst composite generally comprises an agglomerate of a plurality of catalyst composite components agglomerated with a binder. The catalyst composite components may include a reactive species, a support, a promoter, an ion exchange material, or a combination comprising at least one of the foregoing catalyst composite components. At least a portion of the reactive species, promoter, and/or ion exchange material may be disposed onto a surface of at least a portion of the support to form supported catalyst particles prior to being agglomerated. Alternatively, all of the catalyst composite components may be agglomerated as unsupported components. In contrast to the prior art, the present catalyst composites advantageously have increased surface areas, which permit the use of reduced amounts of composite while obtaining similar or improved reaction catalysis. Further, any bypassing or fluidizing of the catalyst by a reactive mixture is effectively eliminated and any pressure drop that may occur is reduced.

The term “catalyst” has its ordinary meaning as used herein, and generically describes a material which increases the rate of a chemical reaction but which is not consumed by the reaction. Further, a catalyst affects only the rate of the reaction; it changes neither the thermodynamics of the reaction nor the equilibrium composition. Further, as used herein to describe the catalyst composites or components of the catalyst composites, the term “catalyst” is intended to refer to heterogeneous catalysts, as opposed to homogeneous or biological catalysts. The term “reactive species” is used herein for convenience to refer generically to an active component of the catalyst during a chemical reaction process. The term “promoter” has its ordinary meaning as used herein and generally describes a material that is not catalytically active by itself but, when in the presence of the reactive species, enhances the performance of the reactive species. The term “support” has its ordinary meaning as used herein and generally describes an inactive component of the catalyst during the chemical reaction process. The terms “reaction mixture” or “reactant mixture” are used herein for convenience to refer generically to any reactants of a reaction that are brought into contact with a catalyst.

Also, as used herein, the terms “first,” “second,” and the like do not denote any order or importance, but rather are used to distinguish one element from another, and the terms “the”, “a”, and “an” do not denote a limitation of quantity, but rather denote the presence of at least one of the referenced item. Furthermore, all ranges disclosed herein are inclusive of the endpoints and independently combinable.

In one embodiment, the reactive species comprises a metal or metal oxide, comprising an element of Groups 3-10 and 14 of a Periodic Table of Elements. Preferably, the reactive species comprises a precious metal or precious metal oxide. Precious metals comprise the elements of Groups 8, 9, and 10 of the Periodic Table of Elements. In one exemplary embodiment, the reactive species is a platinum oxide.

In one embodiment, when the reactive species comprises a metal oxide, the metal of the metal oxide is desirably in its highest possible oxidation state. In another embodiment, for metals with multiple oxidation states, the metal of the metal oxide may be partially oxidized. For example, with platinum oxides, platinum may be in the 2⁺ and/or in the 4⁺ oxidation state.

In one embodiment, the reactive species is in the form of fine powder particles. In another embodiment, the reactive species is in the form of coarse powder particles. Alternatively, the reactive species may be a mixture of fine and coarse powder particles. An average particle size of the reactive species is less than or equal to about 420 micrometers (40 U.S. mesh). More preferably the average particle size of the reactive species is less than or equal to about 105 micrometers (140 U.S. mesh).

The support may be a dense or porous solid. In embodiments where a catalyst composite component is disposed onto a surface of the support, if the support is porous the surface onto which the catalyst composite component is adsorbed may include any internal pore surface. The support may be spherical (i.e., spheres or microspheres) or non-spherical (i.e., granules, pellets, powders, monoliths, extrudates, or cylinders).

A suitable support material may exhibit a wide range of chemical and structural properties and comprises materials such as silica, alumina, oxides, mixed oxides, zeolites, carbonates, clays, ceramics, and carbons. Suitable oxides include for example oxides of titanium, aluminum, niobium, silicon, zinc, zirconium, cerium and the like. Examples of suitable mixed oxides include alumina-titania, alumina-zirconia, ceria-zirconia, ceria-alumina, silica-alumina, silica-titania, silica-zirconia, and the like. Suitable zeolites include any of the more than about 40 known members of the zeolite group of minerals and their synthetic variants, including for example Zeolites A, X, Y, USY, ZSM-5, and the like, in varying Si to Al ratios. Suitable carbonates include for example carbonates of calcium, barium, strontium, and the like. Examples of suitable clays include bentonite, smectite, montmorillonite, paligorskite, attapulgite, sepiolite, saponite, kaolinite, halloysite, hectorite, beidellite, stevensite, fire clay, ground shale, and the like. Examples of suitable ceramics include earthy or inorganic materials such as silicon nitride, boron carbide, silicon carbide, magnesium diboride, ferrite, steatite, yttrium barium copper oxide, anthracite, glauconite, faujasite, mordenite, clinoptilolite, and the like. Suitable carbons include for example carbon black, activated carbon, including graphitic and non-graphitic forms of carbon which could be produced from any carbonaceous material such as coal, lignite, wood, paddy husk, coir pith, and coconut shell, carbon fibrils, carbon hybrids, and the like.

An average particle size of the support is about 0.1 to 30.0 millimeters (mm). More preferably average particle size of the support is about 0.25 to 0.85 mm. An average pore volume of the support is about 0.001 to about 5.0 cubic centimeters per gram (cm³/g). More preferably, the average pore volume of the support is about 0.01 to about 1 cm³/g. An average surface area of the support is about 1 to about 10,000 meters squared per gram (m²/g). More preferably, the average surface area of the support is about 100 to about 1500 m²/g.

Of these supports, ceramics are preferred. In one embodiment, the support is formed from those ceramics described in U.S. Pat. Nos. 4,725,390 and/or 4,632,876, herein incorporated by reference in their entireties. Other preferred ceramics are those made essentially from nonmetallic minerals (such as mineral clays) by firing at an elevated temperature. More preferred are ceramic materials commercially available under the trade name MACROLITE® by the Kinetico Company. The MACROLITE® ceramic materials are spherically shaped and characterized by having a rough texture, high surface area, and level of moisture absorption of less than about 0.5%. The low level of moisture absorption allows for a reactive species or reactive species precursor to penetrate a minimal depth into the surface of the ceramic, thereby disposing the reactive species onto a surface of the support, an optimum location for subsequent contact with a reaction mixture. The surface area of the MACROLITE® ceramic materials is believed to be on about 103 m²/g.

The promoter is a different material or composition than the reactive species. Suitable promoters include compositions comprising a Group 3-7 or 14 element or Rare Earth element of the Periodic Table of Elements, or a combination comprising at least one of the foregoing elements. Rare Earth elements include lanthanum, actinium, the Lanthanide series, and the Actinide series. Preferred promoters are Rare Earth oxides, including for example lanthanum, cerium, neodymium, and thorium oxides. In one embodiment, the promoter is in the form of fine powder particles. In another embodiment, the promoter is in the form of coarse powder particles. Alternatively, the promoter may be a mixture of fine and coarse powder particles. An average particle size of the promoter is less than or equal to about 420 micrometers (40 U.S. mesh). More preferably the average particle size of the promoter is less than or equal to about 177 micrometers (80 U.S. mesh). A molar ratio of the reactive species to the promoter is preferably about 0.3:1 to about 100:1. More preferably, the molar ratio of the reactive species to the promoter is about 10:1.

The ion exchange material (i.e., a natural or synthetic material that can undergo an ion exchange reaction) is a different material or composition from the support. Ion exchange materials include, for example, ion exchange coals, mineral ion exchangers, synthetic inorganic ion exchangers, organic ion exchangers or the like, or a combination comprising at least one of the foregoing ion exchange materials. Suitable ion exchange coals include, for example, coals comprising weak acid moieties, such as a carboxylic acid functional group. Suitable mineral ion exchangers include, for example, ferrous aluminosilicates with cation exchange properties, (e.g., analcite, chabazite, glauconites, harmotome, heulandile, natrolite, montmorillonite, beidellite, and the like) or aluminosilicates with anion exchange properties (e.g., apatite, hydroxyapatite, monotmorillonite, kaolinite, feldspars, sodalites, cancrinites, and the like). Examples of suitable synthetic inorganic ion exchangers include microcrystals embedded in a porous clay binder, such as prepared by combining oxides of Groups 4 of the Periodic Table with oxides of Groups 5 and/or 6 and embedding them in the clay binder. Suitable organic ion exchangers include polyelectrolytes such as phenols, styrenes, or acrylates with cation exchange moieties (e.g., sulfonic acid group, carboxylic acid group, or the like) or anion exchange moieties (e.g., trimethylammonium group, dimethylethanolammonium group, or the like).

An average particle size of the ion exchange material is 0.1 to 30.0 mm. More preferably average particle size of the support is about 0.25 to 0.85 mm. When the ion exchange material is an organic ion exchanger it further comprises a crosslinking agent, wherein the crosslinking agent is in an amount of about 4 to about 55% wt of the total ion exchange material used. In one embodiment, a copolymer of styrene and divinylbenzene (DVB), where DVB is known the crosslinking agent is used, and DVB comprises about 4 to about 55% wt of the copolymer.

The binder provides a means of attachment for the components of the catalyst composites. The binder may be any material that will agglomerate the catalysts composite components and is compatible with the reactant mixture. The binder material is also chosen such that the structural integrity of the catalyst composite essentially remains constant under reaction conditions. Suitable binder materials include non-crosslinked and crosslinked thermoplastic polymers, with an average molecular weight of greater than about 10². When crosslinked thermoplastic polymers are used, an amount of crosslinking may be about 0.1 to about 90%. Preferred thermoplastic polymers include epoxies, perfluoropropylalkoxys, phenolics, polyacetals, polyacrylics, polyalkyls, polyamideimides, polyamides, polyanhydrides, polyaramides, polyarylates, polyarylsulfones, polybenzimidazoles, polybenzothiazinophenothiazines, polybenzothiazoles, polybenzoxazoles, polybutadienes, polycarbonates, polycarboranes, polychlorotrifluoroethylenes, polychlorotrifluoroethylenes, polydibenzofurans, polydioxoisoindolines, polyesters, polyether etherketones, polyether ketone ketones, polyetherimides, polyetherketones, polyethersulfones, polyethylene tetrafluoroethylenes, polyethyleneimines, polyethylenes, polyhexafluoropropylene-co-tetrafluoroethylenes, polyimides, polyisoprenes, polymethacrylonitriles, polymethyl methacrylates, polymethylacrylates, polyolefins, polyoxabicyclononanes, polyoxadiazoles, polyoxindoles, polyoxoisoindolines, polyperfluopromethylalkoxys, polyperfluoromethylalkoxys, polyphenylene sulfides, polyphosphazenes, polyphthalides, polypiperazines, polypiperidines, polypyrazinoquinoxalines, polypyrazoles, polypyridazines, polypyridines, polypyromellitimides, polyquinoxalines, polysilazanes, polysiloxanes, polystyrenes, polysulfides, polysulfonamides, polysulfonates, polysulfones, polytetrafluoroethylenes, polythioesters, polytriazines, polytriazoles, polyureas, polyurethanes, polyvinyl acetates, polyvinyl alcohols, polyvinyl esters, polyvinyl ethers, polyvinyl halides, polyvinyl ketones, polyvinyl nitriles, polyvinyl thioethers, polyvinylidene fluorides, polyvinylpyrrolidones, or the like, or a copolymer of at least two of the foregoing thermoplastic materials, or a combination comprising at least one of the foregoing thermoplastic materials.

In embodiments where a supported catalyst particle is formed prior to being agglomerated, the reactive species, and/or the promoter, and/or the ion exchange material, may be disposed onto the surface of the support by any of a number of techniques including for example impregnation, co-precipitation, deposition-precipitation, ion-exchange, dipping, spraying, vacuum deposition, adhesion, chemical bonding, or the like, or a combination comprising at least one of the foregoing disposing techniques.

Once formed, the plurality of catalyst composite components are mixed with the binder to form a homogeneous or substantially homogeneous mixture. Alternatively, the plurality of catalyst composite components may first be ground into fine particles and then mixed with the binder to form a homogeneous or substantially homogeneous mixture. The mixture of the plurality of catalyst composite components and binder may then be heat and pressure treated, such as with an extruder, compression molder, injection molder, or the like, or a combination comprising at least one of the foregoing, to produce the catalyst composite. Depending on the type heat and pressure treatment, a lubricant may be used as an additive to facilitate formation of the catalyst composite. The lubricant is selected such that catalyst composite properties are essentially not affected.

The reactive species of each of the plurality of catalyst particles may be activated before or after formation of the mixture or before or after formation of the catalyst composite. The reactive species may be activated from about 100 to about 850 degrees Celsius (° C.). Activation of the reactive species may take from about 10 to about 240 minutes. Activation of the reactive species may be carried out, for example, in the presence of air, oxygen, water, hydrogen, or the like, or a combination comprising at least one of the foregoing.

The composition and amount of each component of the catalyst composite is selected to provide effective catalytic activity and selectivity for the chemical process to be catalyzed. Desirably, the catalyst composite comprises about 0.01 to about 99 weight percent (wt %) reactive species whether supported or unsupported, about 20 to about 99 wt % support, less than or equal to about 60 wt % promoter whether supported or unsupported, less than or equal to about 60 wt % ion exchange material whether supported or unsupported, and about 0.01 to about 25 wt % binder, based on the total weight of the catalyst composite.

Myriad catalyst composites, as illustrated by the embodiments in the figures, may be formed from the permutations of types and sizes of the aforedescribed catalyst composite components.

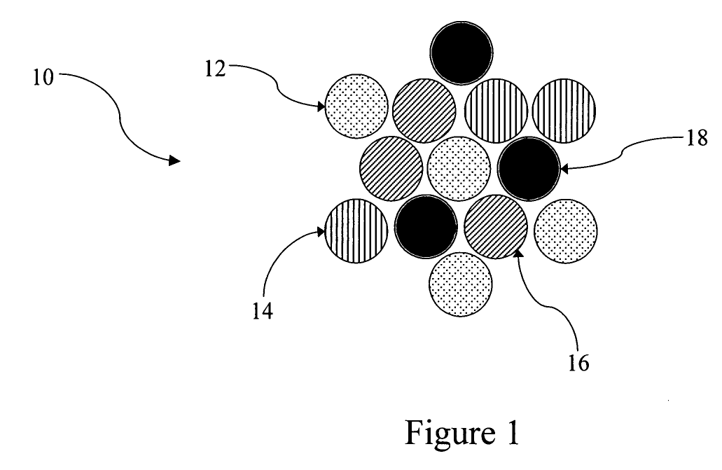

In one exemplary embodiment, shown as FIG. 1, a catalyst composite 10 comprises an agglomerate of reactive species 12, supported catalyst particles 14, promoters 16, and ion exchange materials 18 held together by the binder (not shown). Catalyst composite 10 is desirably formed from catalyst composite components that are about 3 nanometers to about 420 micrometers (40 U.S. Mesh) and is about 0.595 mm (30 U.S. Mesh) to about 2.83 mm (7 U.S. Mesh) in final form.

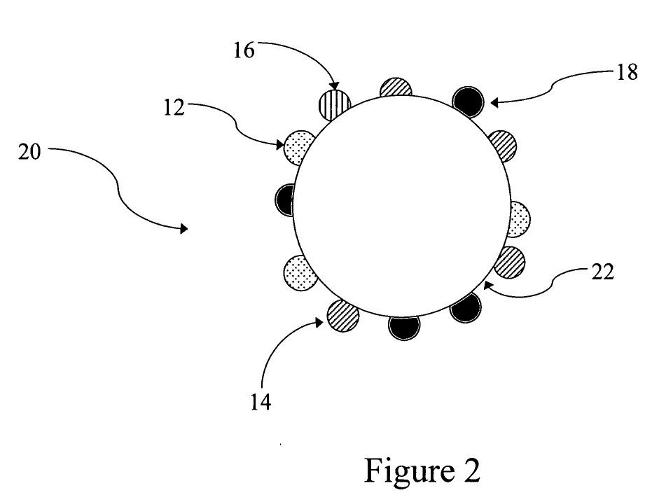

In another exemplary embodiment, shown as FIG. 2, a catalyst composite 20 comprises an agglomerate of reactive species 12, supported catalyst particles 14, promoters 16, and ion exchange materials 18 disposed onto a surface of a larger support particle 22 and held in place by the binder (not shown). Catalyst composite 20 is desirably about 420 micrometers (40 U.S. Mesh) to about 1.68 mm (12 U.S. Mesh) and comprises less than 40 wt % reactive species 12, supported catalyst particles 14, promoters 16, and ion exchange materials 18. An average particle size of the larger support particle 22 is desirably less than about 1 mm (18 U.S. Mesh).

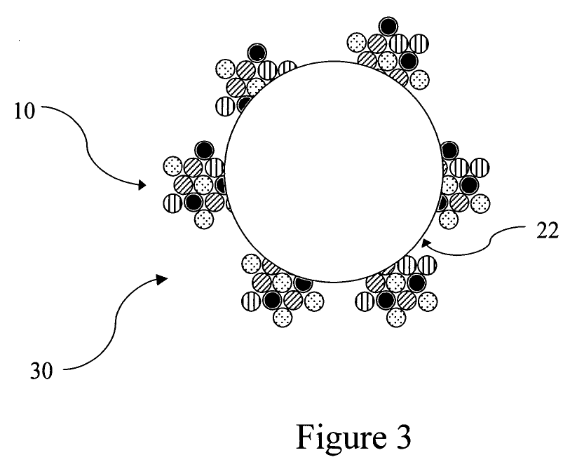

In yet another exemplary embodiment, shown as FIG. 3, a complex catalyst composite 30 comprises an agglomerate of finely ground particles of catalyst composite 10 disposed onto a surface of a larger support particle 22 and held in place by the binder (not shown). Catalyst composite 30 is desirably about 420 micrometers (40 U.S. Mesh) to about 1.68 mm (12 U.S. Mesh) and comprises less than 40 wt % of the finely ground particles of catalyst composite 10. An average particle size of the larger support particle 22 is desirably less than about 1 mm (18 U.S. Mesh).

Although the catalyst composites and/or catalyst composite components are shown as spheres, they may be any shape as determined by their method of synthesis or production.

It should be recognized by one of ordinary skill in the art that the rigidity and structural integrity provided by the binder material results in reduced desorption of the catalyst composite components from the catalyst composite and also effectively eliminates the release of catalyst fines.

The catalyst composites described herein are further advantageous in that they may be used in numerous chemical reaction processes, including among others hydrogenation, dehydrogenation, hydrogenolysis, oxidation, reduction, alkylation, dealkylation, carbonylation, decarbonylation, coupling, isomerization, amination, deamination, hydrodehalogenation, or the like.

A preferred process of use is the oxidative production of a halogen oxide from an alkali metal halite solution. One such process generally comprises employing a cation exchange column for producing an aqueous effluent containing halous acid from the alkali metal halite solution, which is then fed to a catalytic reactor containing the catalyst composite for converting the halous acid to halogen oxide. A second such process generally comprises employing an electrochemical acidification cell for producing an aqueous effluent containing a halous acid from the alkali metal halite solution, which is then fed to a catalytic reactor containing the catalyst composite for converting the halous acid to halogen oxide. A third such process generally comprises mixing an alkali metal halite solution and a mineral acid, which is then fed to a catalytic reactor containing the catalyst composite for converting the halous acid to halogen oxide. In one exemplary embodiment, the catalyst composite may be used in the production of chlorine dioxide from an alkali metal chlorite solution.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A catalyst composite comprising:
an agglomerate of a plurality of catalyst composite components and a binder, wherein the catalyst composite components comprise a reactive species, a support, a promoter, an ion exchange material, or a combination comprising at least one of the foregoing catalyst composite components.

2. The catalyst composite of claim 1, wherein at least a portion of the reactive species is disposed onto a surface of at least a potion of the support.

3. The catalyst composite of claim 1, wherein at least a portion of the promoter is disposed onto the surface of at least a potion of the support.

4. The catalyst composite of claim 1, wherein at least a portion of the ion exchange material is disposed onto the surface of at least a potion of the support.

5. The catalyst composite of claim 1, wherein at least a potion of the reactive species, promoter, and ion exchange material is disposed onto the surface of at least a potion of the support.

6. The catalyst composite of claim 1, wherein the reactive species comprises a metal or metal oxide comprising an element of Groups 3-10 and 14 of a Periodic Table of Elements.

7. The catalyst composite of claim 6, wherein the reactive species comprises a precious metal.

8. The catalyst composite of claim 7, wherein the reactive species further comprises a non-precious metal.

9. The catalyst composite of claim 8, wherein a molar ratio of the precious metal to the non-precious metal is about 0.3:1 to about 100:1.

10. The catalyst composite of claim 1, wherein the support comprises an oxide, mixed oxide, zeolite, alumina, silica, aluminosilicate, carbonate, clay, ceramic, carbon, or a combination comprising at least one of the foregoing.

11. The catalyst composite of claim 1, wherein the promoter comprises a composition comprising a Group 3-7 or 14 element, a Rare Earth element, or a combination comprising at least one of the foregoing elements of the Periodic Table of Elements.

12. The catalyst composite of claim 1, wherein the binder comprises a non-crosslinked thermoplastic polymer, crosslinked thermoplastic polymer, or a combination comprising at least one of the foregoing binder materials.

13. The catalyst composite of claim 1, wherein the reactive species, whether supported or unsupported, is in an amount of about 0.01 to about 99 weight percent (wt %), the support is in an amount of about 20 to about 99 wt %, the promoter, whether supported or unsupported, is in an amount of less than or equal to about 60 wt %, the ion exchange material, whether supported or unsupported, is in an amount of less than or equal to about 60 wt %, and the binder is in an amount of about 0.01 to about 25 wt % binder, and wherein the weight percent is based on the total weight of the catalyst composite.

14. A method for making a catalyst composite comprising:
mixing a plurality of catalyst composite components with a binder to fonn a mixture, wherein the catalyst composite components comprise a reactive species, a support, a promoter, an ion exchange material, or a combination comprising at least one of the foregoing catalyst composite components; and
processing the mixture to form the catalyst composite, wherein the catalyst composite comprises an agglomerate of a plurality of catalyst composite components held together with the binder.

15. The method of claim 14, further comprising:
disposing at least a portion of the reactive species, promoter, ion exchange material, or a combination comprising at least a portion of at least one of the foregoing onto a surface of at least a portion of the support prior to the mixing.

16. The method of claim 14, further comprising grinding the plurality of catalyst composite components into fine powdered particles prior to the mixing.

17. The method of claim 14, further comprising disposing the mixture onto a surface of a larger support prior to processing.

18. The method of claim 14, further comprising activating the reactive species.

19. The method of claim 14, wherein the processing comprises heat and pressure treating.

20. The method of claim 14, further comprising:
grinding the catalyst composite into finely ground particles of catalyst composite;
disposing the finely ground particles of catalyst composite onto a surface of a larger support particle; and
processing the finely ground particles of catalyst composite disposed onto the surface of the larger support particle to form a complex catalyst composite.

21. A method for catalyzing a chemical process, comprising:
contacting a reaction mixture with catalyst composite, wherein the catalyst composite comprises an agglomerate of a plurality of catalyst composite components and a binder, wherein the catalyst composite components comprise a reactive species, a support, a promoter, an ion exchange material, or a combination comprising at least one of the foregoing catalyst composite components; and
increasing a reaction rate for the reaction mixture to produce a product.

22. The method of claim 21, wherein the chemical process comprises hydrogenation, dehydrogenation, hydrogenolysis, oxidation, reduction, alkylation, dealkylation, carbonylation, decarbonylation, coupling, isomerization, amination, deamination, and hydrodehalogenation.

23. The method of claim 21, wherein the chemical process comprises oxidative production of a halogen oxide from an alkali metal halite solution.
